(19) United States
(12) Patent Application Publication
(10) Pub. No.: US 2021/0133373 A1
(43) Pub. Date: May 6, 2021

(54) HYBRID ROUND ROD AND METHOD OF MANUFACTURING SAME

(71) Applicant: SHPAC CO., LTD, Busan (KR)

(72) Inventors: Yun Ju LEE, Yongin-Si (KR); Hye Kyeong LEE, Changwon-Si (KR); Tae Ho HWANG, Busan (KR); Yeon Jung JANG, Tongyeong-Si (KR)

(21) Appl. No.: 17/143,404

(22) Filed: Jan. 7, 2021

Related U.S. Application Data
(63) Continuation of application No. PCT/KR2018/008264, filed on Jul. 23, 2018.

(30) Foreign Application Priority Data
Jul. 18, 2018 (KR) 10-2018-0083634

(51) Int. Cl. G06F 30/20

(52) U.S. Cl. CPC G06F 30/20; F15B 15/14

(57) ABSTRACT

Proposed is a method of manufacturing a hybrid round rod, the method including the step of calculating an optimal ratio between a metal round rod and a composite material layer when manufacturing the hybrid round rod in which the composite material layer is formed on an outer circumferential surface of the metal round rod, in order to reduce the weight of an existing metal round rod such as a rod of a hydraulic cylinder. As such, the optimal ratio between heterogeneous materials can be derived, so that the weight can be reduced while satisfying a target buckling load when manufacturing the hybrid round rod. Thus, the present disclosure can contribute to reduction of the weight of round rods and tubes of metal materials and the weight of related apparatuses.

### REFERENCE TO RELATED APPLICATIONS

This is a continuation of International Patent Application PCT/KR2018/008264 filed on Jul. 23, 2018, which designates the United States and claims priority of Korean Patent Application No. 10-2018-0083634 filed on Jul. 18, 2018, the entire contents of which are incorporated herein by reference.

### FIELD OF THE INVENTION

The present disclosure relates to a hybrid round rod and a method of manufacturing the same. More particularly, the present disclosure relates to a method of manufacturing a hybrid round rod, the method including the step of deriving an optimal ratio between a metal round rod and a composite material layer when manufacturing the hybrid round rod in which the composite material layer is formed on an outer circumferential surface of the metal round rod, in order to reduce the weight of an existing metal round rod such as a cylinder rod.

### BACKGROUND OF THE INVENTION

A hydraulic cylinder is a core component of construction equipment and high place operation cars, and the need to develop a lightweight hydraulic cylinder has recently arisen.

If the weight of the hydraulic cylinder is reduced by 30%, the total weight of construction equipment and high place operation cars can be reduced by 6 to 15%, which can improve energy efficiency in equipment operation, and thus the development of lightweight hydraulic cylinders is attracting attention.

In order to reduce the weight of such hydraulic cylinders, a cylinder tube and a rod are each entirely or partially made of carbon fiber reinforced plastic (CFRP), a high-tech plastic composite material that is attracting attention as a high-strength, high-elasticity, and lightweight structural material.

In particular, in the case of a round cylinder rod, a composite material layer is formed on an outer circumferential surface of the rod using a filament winding technique, so that the rod is manufactured as a hybrid rod in which a metal material and CFRP are mixed, thereby realizing weight reduction.

However, in order to achieve weight reduction while satisfying a target buckling load in manufacturing the hybrid rod, it is necessary to calculate an appropriate ratio between metal and CFRP, and research and development on a method of calculating such a ratio is insufficient.

Therefore, there is a need to develop a technology capable of presenting an optimal ratio between heterogeneous materials of a hybrid rod so as to contribute to the development of a lightweight hydraulic cylinder.

### SUMMARY OF THE INVENTION

Accordingly, the present disclosure has been made keeping in mind the above problems occurring in the related art, and an objective of the present disclosure is to provide a method of manufacturing a hybrid round rod, the method including the step of deriving an optimal ratio between a metal round rod and a composite material layer when manufacturing the hybrid round rod in which the composite material layer is formed on an outer circumferential surface of the metal round rod, in order to reduce the weight of an existing metal round rod such as a rod of a hydraulic cylinder.

The above and other objectives and advantages of the present disclosure will be understood from the following description. In addition, it is understood that the objectives and advantages of the present disclosure will be encompassed widely in the scope of the present disclosure by not only the descriptions in the appended claims and the embodiments of the present disclosure, but also means within the scope of the present disclosure that can be easily inferred therefrom and their combinations.

According to a method of manufacturing a hybrid round rod according to the present disclosure for accomplishing the above objective, the method of manufacturing the hybrid round rod including a metal round rod and a composite material layer formed on an outer circumferential surface of the metal round rod for weight reduction may include the steps of: (a) setting a first diameter OD, a length L, a set buckling load F, an end condition factor n, and a first safety factor SF1 of the hybrid round rod, and setting a material and a modulus of elasticity E of the metal round rod; (b) calculating a slenderness ratio using the length L and values of a second diameter D in a range equal to or less than the first diameter OD to determine a method for calculating a critical buckling load PC of the metal round rod for each of the values of the second diameter ID, (c) calculating the critical buckling load PC and a second safety factor SF2 of the metal round rod for each of the values of the second diameter D by the determined method, and calculating a third safety factor SF3 of the metal round rod closest to the first safety factor SF1 among the respective calculated second safety factors SF2; and (d) deriving an optimal ratio between the metal round rod and the composite material layer for weight reduction by using a second diameter D corresponding to the third safety factor SF3 as a minimum diameter ID_{MIN} of the metal round rod.

In addition, according to a preferred embodiment of the present disclosure, the method for calculating the critical buckling load PC of the metal round rod in the step (b) may use either Rankine's method or Eulers method according to the calculated slenderness ratio.

In addition, according to a preferred embodiment of the present disclosure, the step (d) may be performed by calculating a thickness T of the composite material layer using the minimum diameter ID_{MIN} of the metal round rod and the diameter OD of the hybrid round rod, and calculating a ratio of the composite material layer using the calculated thickness T of the composite material layer and diameter OD of the hybrid round rod.

In addition, a hybrid round rod according to the present disclosure may be manufactured by any one of the above-described methods.

As described above, according to the present disclosure, the following effects can be expected.

As it is possible to derive the optimal ratio between heterogeneous materials that can realize weight reduction while satisfying a target buckling load when manufacturing a hybrid round rod, it is possible to contribute to reduction of the weight of round rods and tubes of metal materials and the weight of related apparatuses.

The above and other effects of the present disclosure will be encompassed widely in the scope of the present disclosure by not only the above-described embodiments and the descriptions in the appended claims, but also effects that can occur within the scope of the present disclosure that can be easily inferred therefrom and possibilities of potential advantages contributing to industrial development.

### BRIEF DESCRIPTION OF THE DRAWINGS

FIG. 1 is a view illustrating a hybrid round rod according to the present disclosure.

FIG. 2 is a flow chart illustrating a method of manufacturing a hybrid round rod according to the present disclosure.

FIG. 3 is a graph illustrating data calculated through a first embodiment of a method of manufacturing hybrid round rod according to the present disclosure.

FIG. 4 is a graph illustrating data calculated through a second embodiment of a method of manufacturing hybrid round rod according to the present disclosure.

FIG. 5 is a graph illustrating data calculated through a third embodiment of a method of manufacturing hybrid round rod according to the present disclosure.

FIG. 6 is a graph illustrating data calculated through a fourth embodiment of a method of manufacturing hybrid round rod according to the present disclosure.

FIG. 7 is an image of a hybrid round rod, a metal round rod, and a CFRP tube manufactured by the method of manufacturing hybrid round rod according to the present disclosure illustrating the state after a buckling test.

FIG. 8 is a table illustrating the results of the buckling test performed on the hybrid round rod, the metal round rod, and the CFRP tube manufactured by the method of manufacturing hybrid round rod according to the present disclosure.

FIG. 9 is a graph illustrating buckling result values of FIG. 8.

### DETAILED DESCRIPTION OF THE INVENTION

Hereinafter, exemplary embodiments of the present disclosure will be described in detail with reference to the accompanying drawings. Prior to the description, advantages and features of the present disclosure and methods of achieving the advantages and features will be clear with reference to embodiments described in detail below when taken in conjunction with the accompanying drawings. Terms used in this specification are for the purpose of describing the embodiments and thus should not be construed as limiting the present disclosure, and it is noted that the singular forms are intended to include the plural forms as well, unless the context clearly indicates otherwise. Further, in the description, a term indicating the direction is for aiding understanding of the description and can be changed according to the viewpoint.

The present disclosure is to provide a method of manufacturing a hybrid round rod, the method including the step of deriving an optimal ratio between a metal round rod and a composite material layer when manufacturing the hybrid round rod in which the composite material layer is formed on an outer circumferential surface of the metal round rod, in order to reduce the weight of an existing metal round rod such as a rod of a hydraulic cylinder.

In deriving the optimal ratio between the metal round rod and the composite material layer according to the present disclosure, it is noted that the physical properties of the composite material layer and the numerical values for strength against buckling are presented only as data obtained from the results of a buckling test.

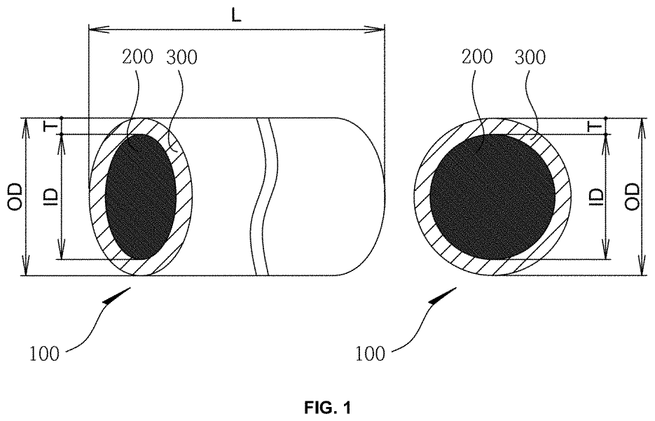

As illustrated in FIG. 1, the hybrid round rod 100 according to the present disclosure includes the metal round rod 200 and the composite material layer 300 formed on the outer circumferential surface of the metal round rod 200, and a diameter OD of the hybrid round rod 100 includes a diameter ID of the metal round rod 200 and a thickness T of the composite material layer 300.

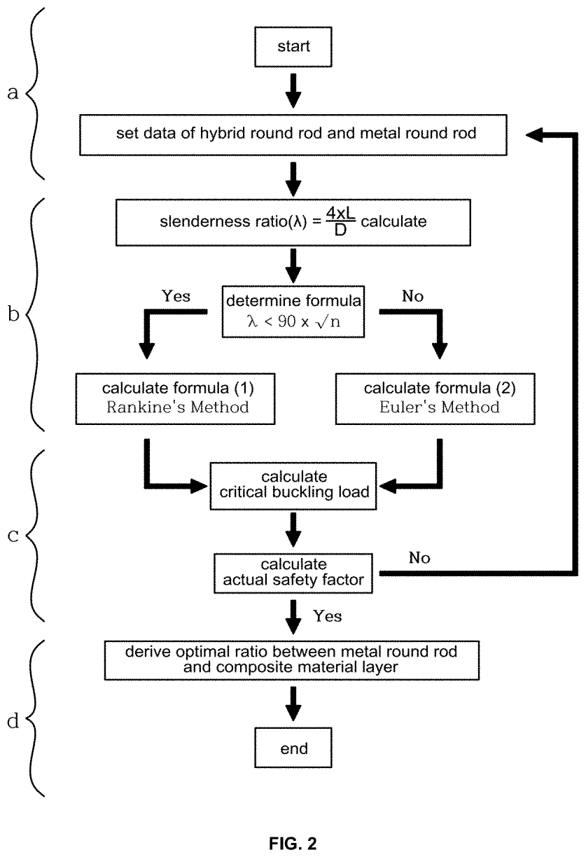

Referring to FIG. 2 in conjunction with the above-described drawing, in the method including the step of deriving the optimal ratio between the metal round rod 200 and the composite material layer 300 of the hybrid round rod 100, a step (a) is performed, in which a first diameter OD, which is a set diameter, a length L, a set buckling load F, an end condition factor n, and a first safety factor SF1, which is a set safety factor, of the hybrid round rod 100 are set, and physical properties such as material, modulus of elasticity E, and density of the metal round rod 200 are set.

In the step (a), data for deriving the optimal ratio of the composite material layer 300 is calculated by setting a target dimension of each of the hybrid round rod 100 and the metal round rod 200.

Next, a step (b) is performed, in which a method for calculating a critical buckling load PC of the metal round rod 200 is determined by calculating a slenderness ratio A using the length L and values of a second diameter D in the range equal to or less than the first diameter OD. Here, the second diameter D include values in the range equal to or less than the first diameter OD, and when the first diameter OD is 70 mm, may include all length values of equal to or less than 70 mm.

In the step (b), the slenderness ratio A is calculated by Formula 1 below using the length L and each of the values of the second diameter D, and the method for calculating the critical buckling load PC of the metal round rod 200 according to each of the respective calculated values of the slenderness ratio A is determined.

When each of the calculated values of the slenderness ratio A falls within the range of Formula 2, the critical buckling load PC of the metal round rod 200 is calculated using Rankine's method as in Formula 4, and when each of the values of the slenderness ratio A falls within the range of Formula 3, the critical buckling load PC of the metal round rod 200 is calculated using Euler's method as in Formula 5.

$$\begin{matrix}λ = \frac{L}{K} = \frac{4 \times L}{D} & [ Formula 1 ] \\ λ < 90 \times \sqrt{n} & [ Formula 2 ] \\ λ \geq 90 \times \sqrt{n} & [ Formula 3 ] \\ PC = \frac{{σ}_{c} \times Ar}{1 + \frac{a}{N} \times {( \frac{L}{K} )}^{2}} & [ Formula 4 ] \\ PC = \frac{n \times {π}^{2} \times E \times I}{{L}^{2}} & [ Formula 5 ]\end{matrix}$$

Subsequently, a step (c) is performed, in which the critical buckling load PC, and a second safety factor SF2 of the metal round rod 200 are calculated using the determined method for calculating the critical buckling load PC and each of the values of the second diameter D, and a third safety factor SF3 of the metal round rod 200 closest to the first safety factor SF1 among the respective calculated second safety factors SF2 is calculated. Here, each of the second safety factors SF2 is a value calculated for the length L and each of the values of the second diameter D, and the third safety factor SF2 is a value closest to the first safety factor SF1 among the calculated second safety factors SF2.

Here, if the calculated value of the slenderness ratio A falls within the range to which the Euler's method should be applied and thus the critical buckling load PC is calculated using Euler's method, the value of the slenderness ratio A may fall within the range to which Rankine's method should be applied in the course of gradually decreasing the values of the second diameter D. In this case, a value of the critical buckling load PC calculated using Euler's method and a value of the critical buckling load PC calculated using Rankine's method cannot be organically linked because these values are for hybrid round rods of different structures under the structural boundary conditions of the hybrid round rods.

Therefore, if the critical buckling load PC is calculated using Euler's method and is calculated using Rankine's method as the values of the second diameter D are decreased, the critical buckling load PC calculated using Rankine's method should be interpreted separately from the critical buckling load PC calculated using Euler's method.

Finally, a step (d) is performed, in which the optimal ratio between the metal round rod 200 and the composite material layer 300 for weight reduction is derived by using a second diameter D corresponding to the third safety factor SF3 as a minimum diameter ID_{MIN} of the metal round rod 200.

In the step (d), as described above, since the present disclosure is for calculating the optimal ratio between the metal round rod 200 and the composite material layer 300 for weight reduction without taking into account the physical properties of the composite material layer 300 and its strength against buckling, the second diameter D corresponding to the third safety factor SF3 is the minimum diameter ID_{MIN} of the metal round rod 200 that satisfies the first safety factor SF1.

Therefore, the thickness T of the composite material layer 300 is calculated by Formula 6 below using the minimum diameter ID_{MIN} of the metal round rod 200, and the optimal ratio of the composite material layer 300 to the hybrid round rod 100 is calculated by Equation 7 below using the calculated thickness T of the composite material layer 300.

$$\begin{matrix}T = \frac{OD - {ID}_{MIN}}{2} & [ Formula 6 ] \\ ratio = \frac{{2}_{T}}{OD} & [ Formula 7 ]\end{matrix}$$

Hereinafter, exemplary embodiments of a method of manufacturing a hybrid round rod will be described to help the understanding of the present disclosure.

TABLE 1
Set value of hybrid round rod

| | | |
|---|---|---|
| Length(L) | 1500 | mm |
| Diameter(OD) | 65 | mm |
| Set applied load(F) | 10000 | kgf |
| End condition factor(n) | 1 | Pinned-Pinned |
| Set safety factor(SF1) | 2 | |

TABLE 2
Set value of metal round rod

| Material | SM45C | High-strength steel |
|---|---|---|
| Modulus of elasticity | 21,000 | kgf/mm² |
| Density | 7.85 | kgf/mm² |

TABLE 3
Table of end condition factor

| | Fixed-Free | Fixed-Pinned | Fixed-Fixed | Pinned-Pinned |
|---|---|---|---|---|
| n | 0.25 | 2.046 | 4 | 1 |

TABLE 4
Table of critical buckling load PC and actual
safety factor SF2 of metal round rod

| D | L | λ | Method | PC | SF2 |
|---|---|---|---|---|---|
| 65 | 1500 | 92.31 | Euler | 80716 | 8.072 |
| 60 | 1500 | 100 | Euler | 58602 | 5.860 |
| 58 | 1500 | 103.45 | Euler | 51170 | 5.117 |
| 55 | 1500 | 109.09 | Euler | 41377 | 4.138 |
| 51 | 1500 | 117.65 | Euler | 30591 | 3.059 |
| 46 | 1500 | 130.43 | Euler | 20246 | 2.025 |
| 39 | 1500 | 153.45 | Euler | 10461 | 1.046 |

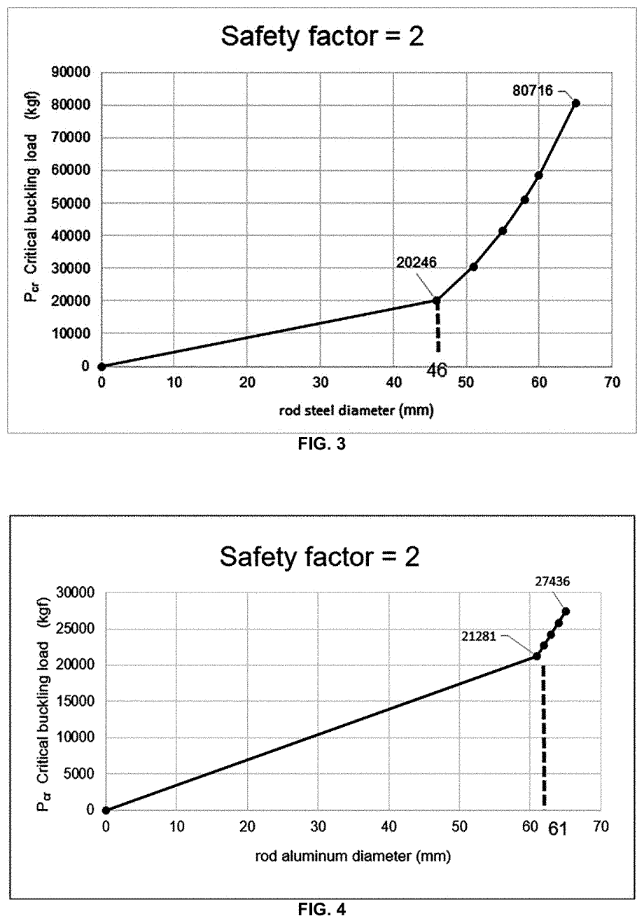

As illustrated in Tables 1 to 4 and FIG. 3, as a result of calculating respective slenderness ratios A with values of a second diameter D and then calculating critical buckling loads PC and second safety factors SF2 of the metal round rod, a second safety factor SF2, which was the closest to the first safety factor SF1 among the second safety factors SF2, was 2.025, and this value of 2.025 was a third safety factor SF3. In addition, a minimum diameter ID_{MIN} of the metal round rod corresponding to the third safety factor SF3 was 46 mm. Thus, an optimal thickness T of a composite material layer was 9.5 mm, and the ratio of the composite material layer in the hybrid round rod was 29.2% (0.0292).

TABLE 5
Set value of hybrid round rod

| | | |
|---|---|---|
| Length(L) | 1500 | mm |
| Diameter(OD) | 65 | mm |
| Set applied load(F) | 10000 | kgf |
| End condition factor(n) | 1 | Pinned-Pinned |
| Set safety factor(SF1) | 2 | |

TABLE 6
Set value of metal round rod

| Material | Al7075 | Aluminum |
|---|---|---|
| Modulus of elasticity | 7183.01 | kgf/mm² |
| Density | 2.70 | kgf/mm² |

TABLE 7
Table of end condition factor

| | Fixed-Free | Fixed-Pinned | Fixed-Fixed | Pinned-Pinned |
|---|---|---|---|---|
| n | 0.25 | 2.046 | 4 | 1 |

TABLE 8
Table of critical buckling load PC and actual safety
factor SF2 of metal round rod

| D | L | λ | Method | PC | SF2 |
|---|---|---|---|---|---|
| 65 | 1500 | 92.31 | Euler | 27436 | 2.744 |
| 61 | 1500 | 98.36 | Euler | 21281 | 2.128 |
| 60 | 1500 | 100 | Euler | 19919 | 1.992 |
| 55 | 1500 | 109.09 | Euler | 14064 | 1.406 |
| 54 | 1500 | 111.11 | Euler | 13069 | 1.307 |
| 51 | 1500 | 117.65 | Euler | 10398 | 1.040 |

As illustrated in Tables 5 to 8 and FIG. 4, as a result of calculating respective slenderness ratios A with values of a second diameter D and then calculating critical buckling loads PC and second safety factors SF2 of the metal round rod, a second safety factor SF2, which was the closest to the first safety factor SF1 among the second safety factors SF2, was 2.128, and this value of 2.128 was a third safety factor SF3. In addition, a minimum diameter ID_{MIN} of the metal round rod corresponding to the third safety factor SF3 was 61 mm. Thus, an optimal thickness T of a composite material layer was 2 mm, and the ratio of the composite material layer in the hybrid round rod was 6.15% (0.0615).

TABLE 9
Set value of hybrid round rod

| | | |
|---|---|---|
| Length(L) | 700 | mm |
| First Diameter(OD) | 65 | mm |
| Set applied load(F) | 10000 | kgf |
| End condition factor(n) | 1 | Pinned-Pinned |
| First safety factor(SF1) | 2 | |

TABLE 10
Set value of metal round rod

| Material | SM45C | High-strength steel |
|---|---|---|
| Modulus of elasticity | 21,000 | kgf/mm² |
| Density | 7.85 | kgf/mm² |

TABLE 11
Table of end condition factor

| | Fixed-Free | Fixed-Pinned | Fixed-Fixed | Pinned-Pinned |
|---|---|---|---|---|
| n | 0.25 | 2.046 | 4 | 1 |

TABLE 12
Table of compressive strength σc and experimental
constant a in Rankine's method

| | Material | | | | |
|---|---|---|---|---|---|
| | | General | High-strength | | |
| Integer | Cast iron | steel | steel | Wood | Al7075 |
| σ_{c} | 56 | 34 | 49 | 5 | 51 |
| | 0.00063 | 0.00013 | 0.0002 | 0.00133 | 0.0007 |

TABLE 13
Table of critical buckling load PC and actual safety
factor SF2 of metal round rod

| D | L | λ | Method | PC | SF2 |
|---|---|---|---|---|---|
| 65 | 700 | 43.08 | Rankine | 118587 | 11.859 |
| 60 | 700 | 46.67 | Rankine | 96509 | 9.651 |
| 55 | 700 | 50.91 | Rankine | 76673 | 7.667 |
| 48 | 700 | 58.33 | Rankine | 52761 | 5.276 |
| 44 | 700 | 63.64 | Rankine | 41165 | 4.117 |
| 40 | 700 | 70 | Rankine | 31099 | 3.110 |
| 35 | 700 | 80 | Rankine | 20677 | 2.068 |
| 32 | 700 | 87.5 | Rankine | 15569 | 1.557 |

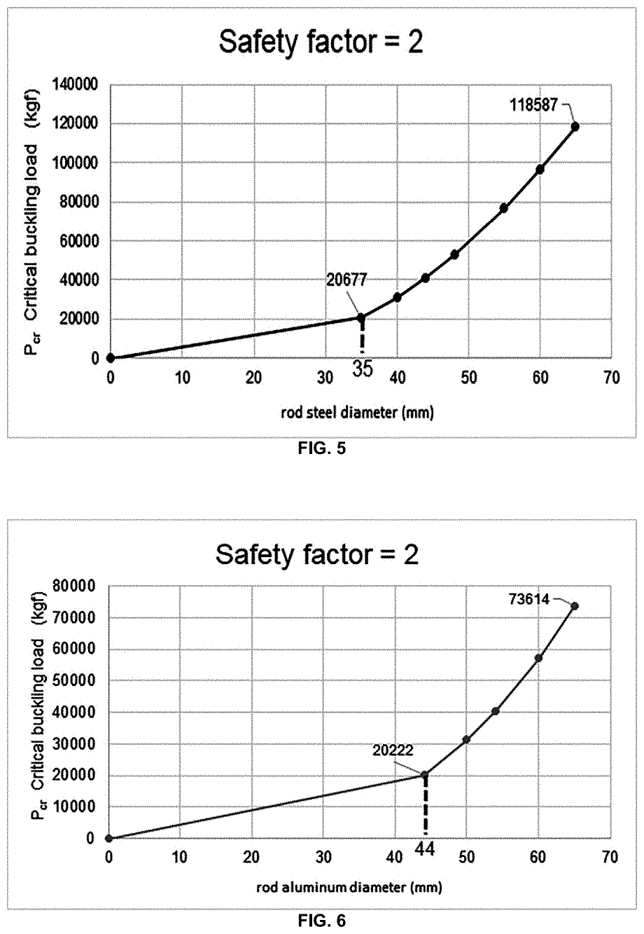

As illustrated in Tables 9 to 13 and FIG. 5, as a result of calculating respective slenderness ratios A with values of a second diameter D and then calculating critical buckling loads PC and second safety factors SF2 of the metal round rod, a second safety factor SF2, which was the closest to the first safety factor SF1 among the second safety factors SF2, was 2.068, and this value of 2.068 was a third safety factor SF3. In addition, a minimum diameter ID_{MIN} of the metal round rod corresponding to the third safety factor SF3 was 35 mm. Thus, an optimal thickness T of a composite material layer was 15 mm, and the ratio of the composite material layer in the hybrid round rod was 46.2% (0.462).

TABLE 14
Set value of hybrid round rod

| | | |
|---|---|---|
| Length(L) | 700 | mm |
| First Diameter(OD) | 65 | mm |
| Set applied load(F) | 10000 | kgf |
| End condition factor(n) | 1 | Pinned-Pinned |
| First safety factor(SF1) | 2 | |

TABLE 15
Set value of metal round rod

| Material | Al7075 | Aluminum |
|---|---|---|
| Modulus of elasticity | 7183.01 | kgf/mm² |
| Density | 2.70 | kgf/mm² |

TABLE 16
Table of end condition factor

| | Fixed-Free | Fixed-Pinned | Fixed-Fixed | Pinned-Pinned |
|---|---|---|---|---|
| n | 0.25 | 2.046 | 4 | 1 |

TABLE 17
Table of compressive strength σc and experimental
constant a in Rankine's method

| | Material | | | | |
|---|---|---|---|---|---|
| | | General | High-strength | | |
| Integer | Cast iron | steel | steel | Wood | Al7075 |
| σ_{c} | 56 | 34 | 49 | 5 | 51 |
| | 0.00063 | 0.00013 | 0.0002 | 0.00133 | 0.0007 |

TABLE 18
Table of critical buckling load PC and actual safety
factor SF2 of metal round rod

| D | L | λ | Method | PC | SF2 |
|---|---|---|---|---|---|
| 65 | 700 | 43.08 | Rankine | 73614 | 7.361 |
| 60 | 700 | 46.67 | Rankine | 57121 | 5.712 |
| 54 | 700 | 51.85 | Rankine | 40527 | 4.053 |
| 50 | 700 | 56 | Rankine | 31340 | 3.134 |
| 44 | 700 | 63.64 | Rankine | 20222 | 2.022 |
| 37 | 700 | 75.67 | Rankine | 10948 | 1.095 |
| 34 | 700 | 82.35 | Rankine | 8056 | 0.806 |
| 32 | 700 | 87.5 | Rankine | 6450 | 0.645 |

As illustrated in Tables 14 to 18 and FIG. 6, as a result of calculating respective slenderness ratios A with values of a second diameter D and then calculating critical buckling loads PC and second safety factors SF2 of the metal round rod, a second safety factor SF2, which was the closest to the first safety factor SF1 among the second safety factors SF2, was 2.022, and this value of 2.022 was a third safety factor SF3. In addition, a minimum diameter ID_{MIN} of the metal round rod corresponding to the third safety factor SF3 was 44 mm. Thus, an optimal thickness T of a composite material layer was 10.5 mm, and the ratio of the composite material layer in the hybrid round rod was 32.3% (0.323).

TABLE 19
Comparison of calculation results

| | | | | | | Composite | |
|---|---|---|---|---|---|---|---|
| | | | | | | material | Weight(metal + |
| Item | Material | L | | OD | | layer | CFRP)kg |
| Example 1 | SM45C + CFRP | 1500 | mm | 65 mm | 46 mm | 29.2% | 19.6 + 3.9 = 23.5 |
| Example 2 | AI7075 + CFRP | 1500 | mm | 65 mm | 61 mm | 6.2% | 11.8 + 0.9 = 12.7 |
| Example 3 | SM45C + CFRP | 700 | mm | 65 mm | 65 mm | 46.2% | 5.3 + 2.6 = 7.9 |
| Example 4 | AI7075 + CFRP | 700 | mm | 65 mm | 44 mm | 32.3% | 2.9 + 2.0 = 4.9 |
| Metal(ONLY) | SM45C | 1500 | mm | 65 mm | 65 mm | 0 | 39.1 |
| Metal(ONLY) | SM45C | 700 | mm | 65 mm | 65 mm | 0 | 18.2 |

TABLE 20
Density Table

| | Steel | Aluminum | CFRP |
|---|---|---|---|
| p(kgf/mm²) | 7.85 | 2.70 | 1.60 |

As illustrated in Table 19, when comparing Example 1 of the method of manufacturing the hybrid round rod according to the present disclosure with a 1500 mm long round rod made only of metal, it could be found that there was a difference in weight of 15.6 kg, and this value could contribute to weight reduction.

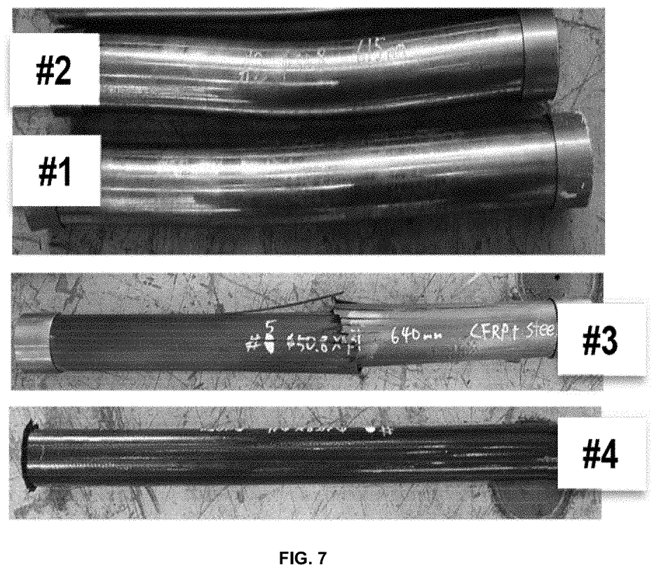

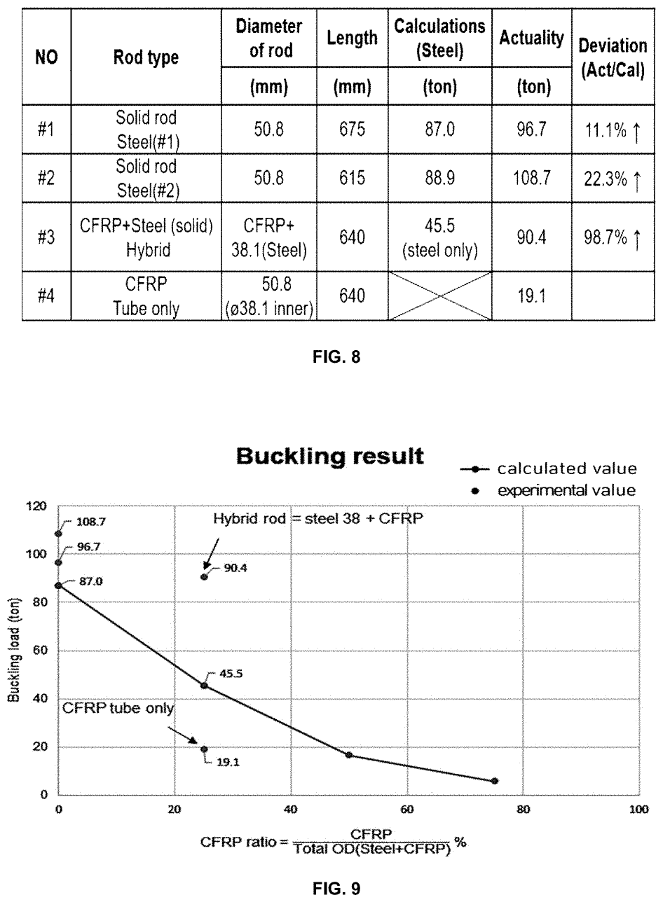

In addition, referring to FIGS. 7 to 9, the hybrid round rod according to the present disclosure was applied to a rod of a hydraulic cylinder and undergone a buckling test together with rods of another metal material and a CFRP tube, and the results are as follows.

In this buckling test, buckling strength was measured through a compression test of each rod at Myongji University in Korea for 2 days from Jun. 21 to 22, 2018.

As illustrated in FIG. 6, as a result of the test, in the case of the hybrid round rod #3 according to the present disclosure, even though the ratio of metal was relatively reduced compared to a metal rod #1, an actual test value (#1: 96.7, #3: 90.4) similar to that of an existing material was exhibited due to a composite material layer. Thus, it was experimentally proved that the composite material layer contributed to weight reduction and provided sufficient strength to the hybrid round rod.

In addition, as illustrated in FIGS. 6 and 7, an actual value of the buckling strength of the hybrid round rod #3 was higher than the sum of an experimental value (19.1) of the CFRP tube #4 alone and a calculated value (45.5) of a metal round rod in the hybrid round rod #3. Thus, when manufacturing the hybrid round rod according to the present disclosure, it is expected that buckling strength equivalent to that of an existing metal round rod can be secured.

The above description of the exemplary embodiments is intended to be merely illustrative of the present disclosure, and those skilled in the art will appreciate that various modifications, additions, and substitutions are possible, without departing from the essential characteristics of the present disclosure. Further, the exemplary embodiments described herein and the accompanying drawings are for illustrative purposes and are not intended to limit the scope of the present disclosure, and the technical idea of the present disclosure is not limited by the exemplary embodiments and the accompanying drawings. The scope of protection sought by the present disclosure is defined by the appended claims and all equivalents thereof are construed to be within the true scope of the present disclosure.

As described above, according to the present disclosure, the following effects can be expected.

As it is possible to derive the optimal ratio between heterogeneous materials that can realize weight reduction while satisfying a target buckling load when manufacturing a hybrid round rod, it is possible to contribute to reduction of the weight of round rods and tubes of metal materials and the weight of related apparatuses.

The above and other effects of the present disclosure will be encompassed widely in the scope of the present disclosure by not only the above-described embodiments and the descriptions in the appended claims, but also effects that can occur within the scope of the present disclosure that can be easily inferred therefrom and possibilities of potential advantages contributing to industrial development.

1. A method of manufacturing a hybrid round rod including a metal round rod and a composite material layer formed on an outer circumferential surface of the metal round rod for weight reduction, the method comprising the steps of:
(a) setting a first diameter (OD), a length (L), a set buckling load (F), an end condition factor (n), and a first safety factor (SF1) of the hybrid round rod, and setting a material and a modulus of elasticity (E) of the metal round rod;
(b) calculating a slenderness ratio using the length (L) and values of a second diameter (D) in a range equal to or less than the first diameter (OD) to determine a method for calculating a critical buckling load (PC) of the metal round rod for each of the values of the second diameter (D);
(c) calculating the critical buckling load (PC) and a second safety factor (SF2) of the metal round rod for each of the values of the second diameter (D) by the determined method, and calculating a third safety factor (SF3) of the metal round rod closest to the first safety factor (SF1) among the respective calculated second safety factors (SF2); and
(d) deriving an optimal ratio between the metal round rod and the composite material layer for weight reduction by using a second diameter (D) corresponding to the third safety factor (SF3) as a minimum diameter (ID_{MIN}) of the metal round rod.

2. The method of claim 1, wherein the method for calculating the critical buckling load (PC) of the metal round rod in the step (b) uses either Rankine's method or Euler's method according to the calculated slenderness ratio.

3. The method of claim 1, wherein the step (d) is performed by calculating a thickness (T) of the composite material layer using the minimum diameter (ID_{MIN}) of the metal round rod and the diameter (OD) of the hybrid round rod, and calculating a ratio of the composite material layer using the calculated thickness (T) of the composite material layer and diameter (OD) of the hybrid round rod.

4. A hybrid round rod manufactured by the method of claim 1.
